(19) United States
(12) Patent Application Publication
(10) Pub. No.: US 2023/0159272 A1
(43) Pub. Date: May 25, 2023

(54) SYSTEM FOR HANDLING AND STORAGE OF ISO CONTAINERS

(71) Applicant: Peter Cannon Holdings Pty Ltd, Paddington, New South Wales (AU)

(72) Inventor: Peter Clive Cannon, Sydney, New South Wales (AU)

(73) Assignee: Peter Cannon Holdings Pty Ltd, Paddington, New South Wales (AU)

(21) Appl. No.: 17/920,447

(22) PCT Filed: Apr. 22, 2020
(86) PCT No.: PCT/AU2020/050388

§ 371 Date: Oct. 21, 2022

(30) Foreign Application Priority Data
May 7, 2019 (AU) 2019901554

(51) Int. Cl. B65G 1/04; B65G 63/00; B66C 19/00; B66C 1/66; B66C 17/20

(52) U.S. Cl. CPC B65G 1/0478; B65G 1/0414; B65G 63/004; B66C 19/002; B66C 1/663; B66C 17/20

(57) ABSTRACT

A system (100) for handling and storage of containers (200), system (100) comprising a structure (102) having storage cells (104) therein. Cells (104) are configured to store a container (200). Cells (104) are arranged in a rectangular prismatic array comprising a plurality of arrays (A₁, A₂ . . . A₁₆). Each array comprises columns (C₁, C₂ . . . C₁₅) and rows (R₁, R₂ . . . R₁₈). Arrays (A₁, A₂ . . . A₁₆) are arranged in pairs on opposite sides of void areas (V₁, V₂ . . . V₈), each of which extends vertically and horizontally through the structure (102). Each cell has a container access opening (106) communicating with its associated void area (V₁, V₂ . . . V₈). Container cranes (108) are provided for each void area (V₁, V₂ . . . V₈). Container engagement assemblies (108c) are releasably engaged with respective opposite longitudinal ends of carrier (108a) of cranes (108). Upon movement into a cell (104), assemblies (108c) engage and are vertically supported by horizontal members (102c) at the top of the cell.

### CROSS-REFERENCE

This application is related to Australian Patent Application No. 2019901554, filed 7 May 2019 and entitled “System for handling and storage of ISO containers”, the entire content of which is incorporated herein by way of reference.

### TECHNICAL FIELD

The disclosure herein relates to a system for handling and storage of ISO or intermodal containers, and will be described hereinafter with reference to that application. However, it will be appreciated that the system, or at least certain aspects thereof, may also find application in relation to the handling and storage of other items.

### BACKGROUND

Conventionally, an ISO or intermodal container terminal comprises a large open area where the containers are stored during transhipment of the containers between transport vehicles, such as from a container ship to a train or truck. In the container terminal, the containers are typically stored in stacks of up to five containers high, with the containers being stacked directly one on top of another. Stacks are generally limited to five containers high for reasons of stack stability and also as common handling equipment used to convey the containers to, from, and within the container terminal, such as straddle carriers and mobile gantry cranes, can typically straddle a stack of no more five containers high.

As a result of the containers being stacked directly one on top of another, to gain access a container lower in the stack, e.g., for loading onto a truck, train or ship, the containers above it must first be removed. Accordingly, significant time is wasted shuffling containers around in the container terminal in order to provide access to desired containers.

Also, as a result of the container stack height typically being limited to five containers high, the area required for the container terminal is greater than it would be if the container stacks could be more than five containers high.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Throughout this specification the words “comprise”, “include”, “have”, and variations such as “comprises”, “includes”, “has”, “comprising”, “including” and “having”, will be understood to imply the inclusion of a stated element, integer or step, or group of elements, integers or steps, but not the exclusion of any other element, integer or step, or group of elements, integers or steps.

Disclosed herein is a system for handling and storage of ISO or intermodal containers, the system comprising:

a structure having a plurality of storage cells therein, each of the storage cells being configured to store at least one ISO or intermodal container therein, a first number of the plurality of storage cells being located at a different vertical position within the structure to a second number of the plurality of storage cells,

a void area extending vertically through or alongside the structure,

a third number of the plurality of storage cells, the third number of the plurality of storage cells comprising at least some of the first number of the plurality of storage cells and at least some of the second number of the plurality of storage cells, and each of the cells of the third number of the plurality of storage cells:
being adjacent the void area, and
having a container access opening communicating with the void area;

a container crane mounted relative to the structure and comprising:
an elongate carrier located in the void area, a longitudinal dimension of the carrier defining a first axis,
a hoist assembly mounted to the structure at an upper end of the void area, the hoist assembly connected to the carrier for adjusting a vertical position of the carrier relative to the structure,
first and second container engagement assemblies releasably engaged with respective opposite longitudinal ends of the carrier, each of the container engagement assemblies comprising latching formations for engagement with openings in corner castings of an ISO or intermodal container, the container engagement assemblies being disengageable from the carrier for lateral movement away from the carrier, out of the void area, and into a target cell of the third number of the plurality of storage cells via the respective access opening,
wherein, upon movement of the container engagement assemblies into the target cell, the container engagement assemblies engage and are vertically supported by a portion of the structure associated with the target cell.

A distance between the first and second container engagement assemblies, measured parallel to the first axis, may be adjustable. The longitudinal dimension of the carrier may be adjustable in magnitude. In other words, the carrier is of adjustable length.

The container engagement assemblies may be self-propelled. The container engagement assemblies may comprise a motor, which may be an electric motor. The motor may rotate rollers of the container engagement assemblies for propelling the container engagement assemblies. Power for the electric motor may be supplied by electrical cables extending from the carrier. The electrical cables may extend from an upper region of the structure, through the void area to a central region of the carrier, and outwardly from the central region of the carrier to the container engagement assemblies. A cable extension and retraction assembly may be provided for feeding the electrical cables to and retracting the electrical cables from the container engagement assemblies as the container engagement assemblies move relative to the carrier. The cable extension and retraction assembly may be mounted to the carrier. A cable drum may be mounted to the carrier, the electrical cables being collected in the cable drum during elevation of the carrier relative to the structure and being fed out from the cable drum during lowering of the carrier relative to the structure.

The structure may comprise a three dimensional array of interconnected spaced apart vertical members, each of the cells being defined between first and second pairs of the vertical members. Each of the cells may comprise a pair of parallel, spaced apart horizontal members at its upper end, each of the horizontal members of the pair of horizontal members having a first end adjacent, and fixedly connected relative to, a respective one of the cell's first pair of vertical members, and an opposite second end adjacent, and fixedly connected relative to, a respective one of the cell's second pair of vertical members. Said portion of the structure associated with the target cell may comprise the pair of horizontal members of the target cell. The carrier may comprise a pair of horizontal members having a cross sectional shape complementary to that of the horizontal members of the cells. The horizontal members of the carrier may be perpendicular to said first axis. When engaged with the carrier, the container engagement assemblies engage and are vertically supported by the pair of horizontal members of the carrier. Each of the container engagement assemblies may comprise a roller assembly, comprising one or more roller(s). The horizontal members of the carrier may define a first track engageable by the roller(s) of the roller assembly. The horizontal members of the cells may define a second track engageable by the roller(s) of the roller assembly. When transitioning the container engagement assemblies between the carrier and the target cell, the roller assemblies may transition between engagement with the first track and engagement with the second track. At least one bearing member may extend from the target cell, beyond the associated vertical member and outwardly into the void area. The carrier may comprise a selectively extendable and retractable bearing element, the bearing element, when in an extended configuration, being engageable with the bearing member to support the carrier at a vertical position in which the container engagement assemblies are aligned with the portion of the structure associated with the target cell. The bearing element may extend and retract in a direction that includes at least a horizontal component, the horizontal component being perpendicular to the first axis. The at least one bearing member may comprise a first end of each said horizontal member of the target cell. The first end of each said horizontal member of the target cell may extend beyond the associated vertical member and outwardly from the target cell. The at least one bearing member may be offset, in a direction parallel to the first axis, from the associated vertical member.

The structure may comprise a vertical third track engageable by the carrier, engagement between the carrier and the third track guiding the carrier, and thereby the first and second container engagement assemblies, during adjustment of the vertical position of the carrier relative to the structure. The third track may be provided on or in the vertical members associated with the first ends of the horizontal members of the target cell. The carrier may comprise selectively extendable and retractable guide members, the guide members, when in an extended configuration, engaging the third track. The guide members may extend and retract in a direction that includes at least a horizontal component, the horizontal component being perpendicular to the first axis. A portion of the guide members that engages the third track may comprise a roller.

Each of the cells may comprise at least four container bearing surfaces at its lower end on which a container may be placed for storage in the target cell. A locating projection may extend from each said bearing surface for engaging an opening in a corresponding corner casting of a container stored in the cell. A vertical distance between each of the bearing surfaces and the portion of the structure associated with the target cell may be adjustable to facilitate maintaining a constant distance between a top of a container stored in the target cell and the portion of the structure associated with the cell regardless of the height dimension of the container. For example, a bearing module of adjustable height may be associated with each of the bearing surfaces. Each of the bearing modules may be adjustable between a plurality of predetermined heights. The constant distance may be less than around 12 inches (approximately 300 mm), or less than around 8 inches (approximately 200 mm) or less than around 6 inches (approximately 150 mm), or less than around 4 inches (approximately 100 mm). The height of the bearing modules may change by a predetermined amount when adjusted between each of the predetermined heights and the next of the predetermined heights. The predetermined amount may be 6 inches (approximately 150 mm) or 12 inches (approximately 300 mm). Each of the bearing modules may comprise a said locating projection. Each of the bearing modules may comprise a plurality of stackable articulated blocks. Each of the predetermined heights may be associated with a different stacking configuration of the articulated blocks. Mechanical linkages may interconnect the articulated blocks to facilitate reconfiguring the articulated blocks in each of the stacking configurations. Each of the articulated blocks may comprise a said locating projection.

A fourth number of the plurality of storage cells may be located at a different horizontal position within the structure to a fifth number of the plurality of storage cells. The fourth number of the plurality of storage cells may comprise more than one of the plurality storage cells. The fifth number of the plurality of storage cells may comprise more than one of the plurality storage cells.

The first number of the plurality of storage cells may comprise more than one of the plurality storage cells. The second number of the plurality of storage cells may comprise more than one of the plurality storage cells.

The cells of the third number of the plurality of storage cells may comprise at least a first group (or “column”) of cells aligned on a first vertical axis. The cells of the third number of the plurality of storage cells may comprise at least a second group (or “column”) of cells aligned on a second vertical axis, the void area being between the first and second groups of cells. Each cell of the first group may be aligned with a corresponding cell of the second group on a directly opposite side of the void area. The second group may be a mirror image of the first group about a central vertical plane dividing the first and second groups. The system may comprise a plurality of the void areas, each of the void areas having an associated said at least a first group (or “column”) of cells. The system may comprise a plurality of the void areas, each of the void areas having an associated said at least a first group (or “column”) of cells and an associated said at least a second group (or “column”) of cells, each of the void areas being between the associated first and second groups of cells. The cells of the third number of the plurality of storage cells may comprise a first plurality of groups (or “columns”) of cells, each group of the first plurality of groups having a respective vertical axis on which the cells of that group are aligned. The cells of the third number of the plurality of storage cells may comprise a second plurality of groups (or “columns”) of cells, each group of the second plurality of groups having a respective vertical axis on which the cells of that group are aligned, the void area being between the first plurality of groups and the second plurality of groups. Each cell of the first plurality of groups may be aligned with a corresponding cell of the second plurality of groups on a directly opposite side of the void area. The second plurality of groups may be a mirror image of the first plurality of groups about a central vertical plane dividing the first plurality of groups and the second plurality of groups. The system may comprise a plurality of the void areas, each of the void areas having an associated said first plurality of groups (or “columns”) of cells. The system may comprise a plurality of the void areas, each of the void areas having an associated said first plurality of groups (or “columns”) of cells and an associated said second plurality of groups (or “columns”) of cells, each of the void areas being between the associated first plurality of groups and the associated second plurality of groups. At least one bearing member may extend from each of the cells of the first group of cells, the second group of cells, the first plurality of groups of cells of cells, and/or the second plurality of groups of cells, beyond the associated vertical member and outwardly into the void area. The carrier may comprise a selectively extendable and retractable bearing element, the bearing element, when in an extended configuration, being engageable with the bearing member to support the carrier at a vertical position in which the container engagement assemblies are aligned with the portion of the structure associated with the cell into which the container engagement assemblies are to be moved. In embodiments comprising a said first group of cells and a said second group of cells (or a first plurality of groups of cells and a second plurality of groups of cells), the carrier may comprise a plurality of the bearing elements, some for engaging bearing members associated with the cells of the first group (or first plurality of groups) and others for engaging bearing members associated with the cells of the second group (or second plurality of groups). The bearing element(s) may extend and retract in a direction that includes at least a horizontal component, the horizontal component being perpendicular to the first axis. A maximum fixed width of the carrier measured perpendicular to the first axis may be less than a minimum width of the void area measured perpendicular to the first axis, such that a gap is defined between the carrier and portions of the structure on opposite sides of the void area. The length of the horizontal members of the carrier may define the maximum fixed width of the carrier. The distance between ends of the horizontal members of the cells of the first group of cells (or first plurality of groups of cells) and the horizontal members of the corresponding cells of the second group of cells (or second plurality of groups of cells) may define the minimum width of the void area. When extended, the bearing element(s) may engage a portion of the structure on the opposite side of the void area to the cell into which the container assemblies are to be moved to urge the carrier toward the cell into which the container engagement assemblies are to be moved to reduce the gap between the carrier and that cell to facilitate movement of the container engagement assemblies between the carrier and that cell. When extended, the bearing element(s) may engage a portion of the structure on the opposite side of the void area to the cell into which the container assemblies are to be moved to urge the carrier toward the cell into which the container engagement assemblies are to be moved, thereby to bring the carrier at least substantially into abutment with the horizontal members of that cell to facilitate transitioning of the container engagement assemblies between the carrier and the horizontal members of that cell. The bearing members may comprise a first end of each said horizontal member of the cells of the first group (or first plurality of groups), and, in relevant embodiments, a first end of each said horizontal member of the cells of the second group (or second plurality of groups). The first ends of the horizontal members may extend beyond the associated vertical member and outwardly from the cells. The bearing members may be offset, in a direction parallel to the first axis, from the associated vertical member. Some of the first plurality of groups may be configured to receive longer containers than other of the first plurality of groups. Some of the second plurality of groups may be configured to receive longer containers than other of the second plurality of groups.

The hoist assembly may be moveable horizontally with respect to the structure. The hoist assembly may be self-propelled to facilitate its horizontal movement relative to the structure. The hoist assembly may comprise a motor, which may be an electric motor. The motor of the hoist assembly may rotate rollers of the hoist assembly for propelling the hoist assembly. The hoist assembly may be mounted on horizontal rails of the structure. The horizontal rails may extend parallel to the first axis. The carrier may interlock with the hoist assembly upon elevation of the carrier to the upper end of the void area. The hoist assembly may be locked against movement relative to the structure unless the carrier is interlocked with the hoist assembly. The hoist assembly may comprise at least three hoist cables, each connected to a respective anchor point the carrier. Each of the at least three cables may be independently adjustable to facilitate independent adjustment of the vertical position of the anchor points.

Said openings in corner castings of a container may be openings in upper corner castings of the container. Said openings in corner castings of a container may be top openings in upper corner castings of the container. The latching formations may comprise twistlocks. The latching formations may be extended and retracted in a vertical direction between an extended configuration and a retracted configuration. The latching formations may be engaged with the openings in corner castings of a container when in the extended configuration and the retracted configuration, and when moving therebetween, such that the container may be moved vertically by the extension or retraction of the latching formations. The latching formations may be displaced vertically by less than a predetermined displacement when moving between the extended configuration and the retracted configuration. The predetermined displacement may be less than around 12 inches (approximately 300 mm), or less than around 8 inches (approximately 200 mm) or less than around 6 inches (approximately 150 mm), or less than around 4 inches (approximately 100 mm). The container engagement assemblies may comprise camming mechanisms for moving the latching formations between the extended and retracted configurations.

A container carrier bay may be provided at a lower end of the or each void area. The container carrier bay may be oriented parallel to the first axis, such that a longitudinal axis of a container carried on a container carrier in the bay is parallel to the first axis. The container carrier bay may be adapted to receive a truck trailer and/or a train wagon. The container crane may be lowered to a trailer or wagon in the bay to: unload a container from the trailer or wagon and move the container into one of the cells; or deliver a container from one of the cells to the trailer or wagon.

Also disclosed herein are other inventions comprising any novel combination of features disclosed herein in words and/or in the accompanying drawings.

### BRIEF DESCRIPTION OF DRAWINGS

A system embodying principles disclosed herein will now be described, by way of example only, with reference to the accompanying drawings, in which:

FIG. 1 is a schematic perspective view of the system;

FIG. 2 is a cross sectional view taken vertically through the system of FIG. 1 along line 2-2;

FIG. 3 is a schematic cross sectional view taken vertically through the structure of the system of FIG. 1 along line 3-3;

FIG. 4 is a more detailed schematic cross sectional view taken vertically through the system of FIG. 1 along line 3-3;

FIG. 5 is a schematic perspective view of part of an interior of the system of FIG. 1;

FIG. 6 is a schematic side elevational view of a carrier of the system of FIG. 1;

FIG. 7 is a schematic end elevational view of the carrier of FIG. 6;

FIG. 8 is a schematic end elevational view of the carrier of FIG. 6 with a container engagement assembly engaged therewith, in a configuration for raising or lowering by the hoist assembly;

FIG. 9 is a schematic end elevational view of the carrier and container engagement assembly of FIG. 8, in a configuration for movement of the container engagement assembly into a storage cell;

FIG. 10 is a schematic end elevational view of the container engagement assembly of FIG. 9 after it has disengaged from the carrier and moved into the storage cell;

FIG. 11 is schematic perspective view showing a container bearing module of the system of FIG. 1, shown in a first configuration for use with a 9′6″ ISO container;

FIG. 12 is a schematic perspective view of the container bearing module of FIG. 11, shown in a second configuration for use with a 9′ ISO container;

FIG. 13 is a schematic perspective view of the container bearing module of FIG. 11, shown in a third configuration for use with an 8′6″ ISO container; and

FIG. 14 is a schematic perspective view of the container bearing module of FIG. 11, shown in a fourth configuration for use with an 8′ ISO container.

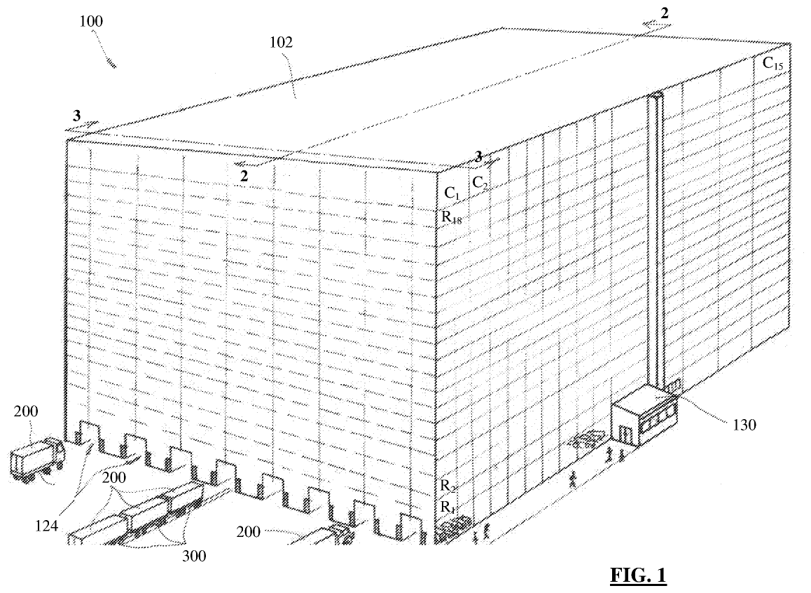

### DESCRIPTION OF EMBODIMENTS

Referring to the drawings, there is provided a system 100 for handling and storage of ISO or intermodal containers 200. The system 100 comprises a structure 102 having a plurality of storage cells 104 therein. In the illustrated embodiment, each of the storage cells 104 is configured to store one container 200 therein.

In the illustrated embodiment, cells 104 are arranged in a rectangular prismatic array comprising sixteen, vertically oriented, parallel rectangular arrays A₁, A₂ . . . A₁₆. Each rectangular array comprises fifteen vertical columns C₁, C₂ . . . C₁₅ and eighteen horizontal rows R₁, R₂ . . . R₁₈. Arrays A₁, A₂ . . . A₁₆ are arranged in pairs on opposite sides of void areas V₁, V₂ . . . V₈, each of which extends vertically through the structure 102 from row R₁ to row R₁₈ and horizontally through the structure from column C₁ to column C₁₅. As such, the cells 104 of any one of rows R₁, R₂ . . . R₁₈ define a first number of the cells 104 that are located at a different vertical position within the structure 102 to a second number of the cells 104 that is defined by the cells 104 of any of the other rows R₁, R₂ . . . R₁₈. Moreover, the cells 104 of each array A₁, A₂ . . . A₁₆ define a third number of the cells 104, the third number of the cells 104 comprising at least some of the first number of the cells 104 and at least some of the second number of the cells 104, and each of the cells 104 of each of the arrays A₁, A₂ . . . A₁₆ is adjacent one of the void areas V₁, V₂ . . . V₈. Moreover, the cells 104 of any one of columns C₁, C₂ . . . C₁₅ (or of any one of arrays A₁, A₂ . . . A₁₆) define a fourth number of the cells 104 that are located at a different horizontal position within the structure 102 to a fifth number of the cells 104 that is defined by the cells 104 of any of the other rows C₁, C₂ . . . C₁₅ (or of any of the other arrays A₁, A₂ . . . A₁₆). Each cell 104 has a container access opening 106 communicating with its associated void area V₁, V₂ . . . V₈.

Container cranes 108 are mounted relative to the structure 102, each container crane 108 being associated with a respective one of the void areas V₁, V₂ . . . V₈ to service the cells 104 of the associated array pairs A₁/A₂, A₁₅/A₁₆. The arrays of each array pair A₁/A₂, . . . A₁₅/A₁₆ are substantially mirror images of each other about a central vertical plane passing through the associated void area. For example, array A₁ is substantially a mirror image of array A₂ about a central vertical plane through void area V₁. Cranes 108 comprise an elongate carrier 108a located in the void area, a longitudinal dimension of the carrier 108a defining a first axis A. Cranes 108 further comprise a hoist assembly 108b mounted to the structure at an upper end of the void area, the hoist assembly connected to the carrier 108a for adjusting a vertical position of the carrier relative to the structure 102. Cranes 108 also comprise first and second container engagement assemblies 108c releasably engaged with respective opposite longitudinal ends of the carrier 108a. A distance between the longitudinal ends of the carrier 108a, and thereby between the first and second container engagement assemblies 108c, is adjustable to configure the crane 108 for engagement with containers 200 of different lengths. Carrier 108a comprises a first carrier frame assembly 108a₃ and a second carrier frame assembly 108a₄. Mechanical linkages 108a₅ extend between assembly 108a₃ and assembly 108a₄, linkages 108a₅ being adjustable to facilitate slewing of assembly 108a₄. Each of the container engagement assemblies 108c comprises latching formations 108c₁ for engagement with openings 202 in corner castings of a container 200. The container engagement assemblies 108c are disengageable from the carrier 108a for lateral movement away from the carrier 108a, out of the void area, and into a target cell 104 of the arrays associated with the void area via the respective access opening 106. Upon movement of the container engagement assemblies 108c into the target cell 104, the container engagement assemblies engage and are vertically supported by a portion of the structure 102 associated with the target cell, as will be described in more detail below.

The container engagement assemblies 108c are self-propelled, comprising roller assemblies 108c₂ having rollers 108c₃ powered by an electric motor of the container engagement assemblies. Power for the motor of the container engagement assemblies 108c is supplied by electrical cables 110 extending from the carrier 108a. The electrical cables 110 extend from an upper region of the structure 102, through the void area to a central region of the carrier 108a, and outwardly from the central region of the carrier to the container engagement assemblies 108c. A cable extension and retraction assembly 112 is provided for feeding the electrical cables 110 to and retracting them from the container engagement assemblies 108c as the container engagement assemblies move relative to the carrier 108a. The cable extension and retraction assembly 112 may be mounted to the carrier. A cable drum 114 is mounted to the carrier 108a, an upper portion of the electrical cables 110 being collected in the cable drum during elevation of the carrier relative to the structure 102 and being fed out from the cable drum during lowering of the carrier relative to the structure.

Each of the cells 104 is defined between first and second pairs of parallel, spaced apart, vertical members 102a, 102b and comprises a pair of parallel, spaced apart, horizontal members 102c at its upper end. Each of the horizontal members 102c of the pair of horizontal members has a first end adjacent, and fixedly connected relative to, a respective one of the cell's first pair of vertical members 102a, and an opposite second end adjacent, and fixedly connected relative to, a respective one of the cell's second pair of vertical members 102b. The horizontal members 102c are offset, in a direction parallel to the first axis A, from the associated vertical members 102a, 201b. The pair of horizontal members 102c comprise the portion of the structure 102 that is engaged by and that supports the container engagement assemblies 108c upon their movement into a cell 104. The carrier 108a comprises a pair of horizontal members 108a₁ having a cross sectional shape complementary to that of the horizontal members 102c of the cells. The horizontal members 108a₁ are perpendicular to axis A. When engaged with the carrier 108a, the container engagement assemblies 108c engage and are vertically supported by the pair of horizontal members 108a₁ of the carrier. The horizontal members 108a₁ of the carrier define a first track engageable by the rollers 108c₃ of the roller assembly 108c₂. The horizontal members 102c of the cells define a second track engageable by the rollers 108c₃ of the roller assembly 108c₂. When transitioning the container engagement assemblies 108c between the carrier 108a and a target cell 104, the roller assemblies 108c₂ transition between engagement with the first track 108a₁ and engagement with the second track 102c.

Ends of the horizontal member 102c extend beyond the vertical members 102a, 102b and outwardly into the associated void area V₁, V₂ . . . V₈ to define bearing members 102c₁ at the base of each cell 104. The carrier 108a comprises selectively extendable and retractable bearing elements 108d. In an extended configuration, bearing elements 108d are engageable with the bearing members 102c₁ to support the carrier 108a at a vertical position in which the rollers 108c₃ of container engagement assemblies 108c are aligned with the horizontal members 102c of a target cell 104. The bearing elements 108d extend and retract in a horizontal direction perpendicular to the first axis A.

The structure 102 comprises a vertical third track 102d engageable by the carrier 108a to guide the carrier, and thereby the first and second container engagement assemblies 108c, during adjustment of the vertical position of the carrier 108a relative to the structure 102. In the illustrated embodiment, the third track 102d takes the form of a substantially V-shaped flange extending along the vertical members 102a, 102b. The carrier 108a comprises selectively extendable and retractable guide members 116 that, when in an extended configuration, engage the third track 102d. In the illustrated embodiment, the guide members 116 take the form of a roller assembly comprising rollers 116a that extend and retract in a horizontal direction perpendicular to the first axis A. The rollers 116a comprise a V-shaped groove extending circumferentially therearound, the groove being of complimentary shape to the V-shaped flange of the third track 102d so as to positively engage therewith.

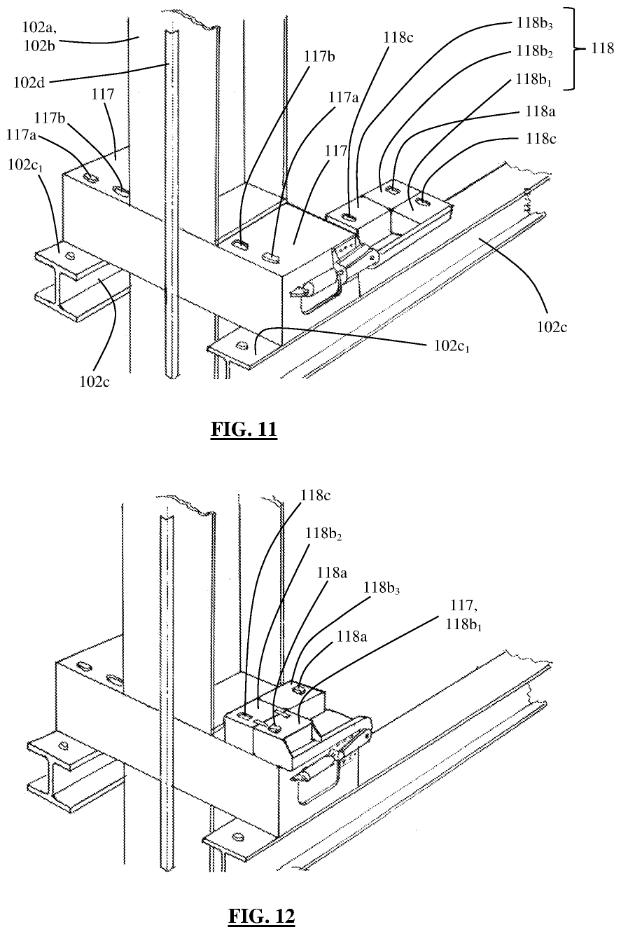

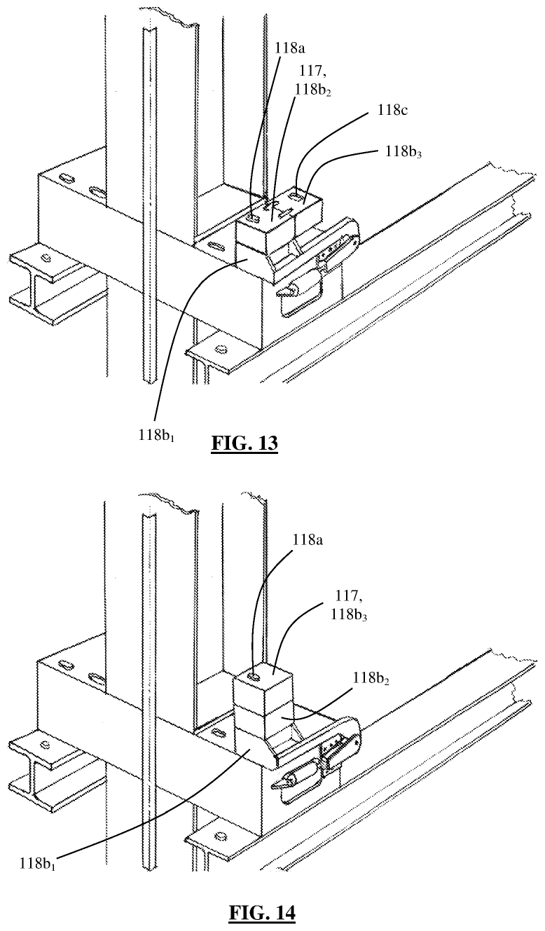

Each of the cells 104 comprises four container bearings, each defining a bearing surface 117, at its lower end. Each bearing is located adjacent, and fixedly connected relative to, a respective vertical member 102a, 102b and/or horizontal member 102c. Each of the bearings comprises a locating projection 117a, 118a, extending from bearing surface 117, for engaging an opening 202 in a corresponding corner casting at the base of a container 200 stored in the cell 104. A resilient stop member 119 is provided in the horizontal members 102c, engagement of which by the container engagement assemblies 108c defines a correct position of the container engagement assemblies 108c for lowering a container 200 onto or raising a container from the bearing surface 117. A vertical distance between each of the bearing surfaces 117 of a cell 104 and the horizontal members 102c of that cell is adjustable to facilitate maintaining a constant distance, which in the illustrated embodiment is less than around 4 inches (approximately 100 mm), between the top of a container 200 stored in the cell and the horizontal members 102c regardless of the height dimension of the container 200. In the illustrated embodiment, this is achieved by each of the bearings comprising a bearing module 118 of adjustable height. Since ISO or intermodal containers 200 typically have a height of eight feet, eight feet and six inches, nine feet, or nine feet and six inches, bearing modules 118 facilitate adjustment of the height of bearing surface 117, in six inch (approximately 150 mm) increments, each associated with one of a plurality of predetermined heights of the bearing modules 118. In the illustrated embodiment, the height adjustability is facilitated by each module 118 comprising a plurality of stackable articulated blocks 118b₁, 118b₂, 118b₃, each of the predetermined heights being associated with a different stacking configuration of the blocks. Mechanical linkages interconnect the articulated blocks 118b₁, 118b₂, 118b₃ to facilitate reconfiguring the articulated blocks in each of the stacking configurations. The different stacking configurations of blocks 118b₁, 118b₂, 118b₃ are shown in FIGS. 11-14, wherein the configuration shown in FIG. 11 is for use with 9′ 6″ high containers, that shown in FIG. 12 is for use with 9′ high containers, that shown in FIG. 13 is for use with 8′6″ high containers and that shown in FIG. 14 is for use with 8′ high containers.

A maximum fixed width of the carrier 108a measured perpendicular to the first axis A is less than a minimum width of the associated void area V₁, V₂ . . . V₈ measured perpendicular to the first axis A, such that a gap 120 is defined between the carrier 108a and portions of the structure 102 on opposite sides of the void area. In the illustrated embodiment, the maximum fixed width of the carrier 108a is defined by the length of the horizontal members 108a₁. The distance between the projecting ends of the horizontal members 102c on opposite sides of the void area define the minimum width of the void area. In the illustrated embodiment, the difference between the minimum width of the void area and the maximum fixed width of the carrier 108a, both measured perpendicular to axis A, is less than around 4 inches (approximately 100 mm). The gap 120 reduces the risk of the carrier 108a snagging on the projecting ends of the horizontal members 102c when the carrier is elevated or lowered by the hoist assembly 108b. When extended, the bearing element 108d on the opposite side of the void area to the cell 104 into which the container assemblies 108c are to be moved engages a portion of the structure 102 on the opposite side of the void area to the cell 104 into which the container assemblies 108c to urge the carrier 108a toward the cell into which the container engagement assemblies are to be moved to reduce or eliminate the gap 120 between the carrier and that cell to facilitate movement of the container engagement assemblies 108c between the carrier and that cell. More specifically, the gap 120 is reduced or eliminated by the horizontal members 108a₁ of the carrier 108a being brought at least substantially into abutment with the horizontal members 102c of the cell 104 to facilitate transitioning of the container engagement assemblies 108c between the carrier and the horizontal members of that cell.

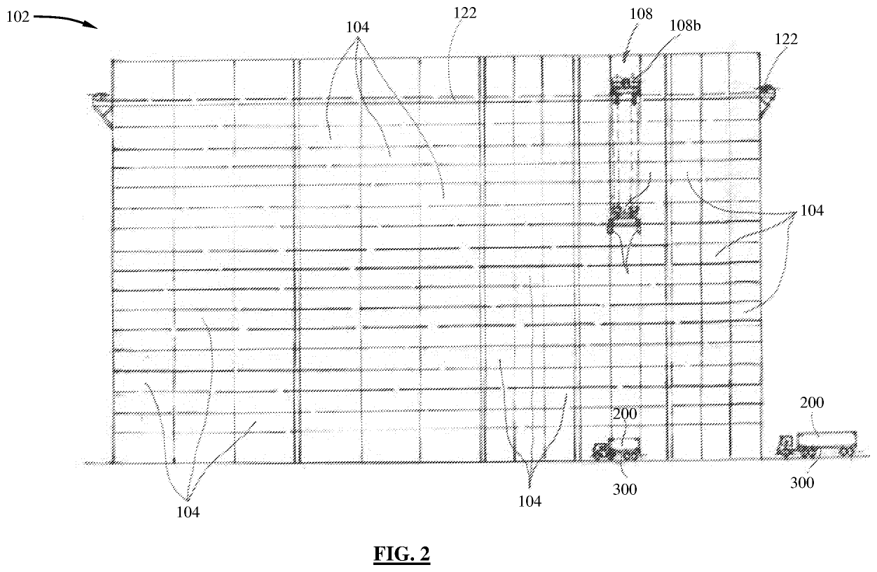

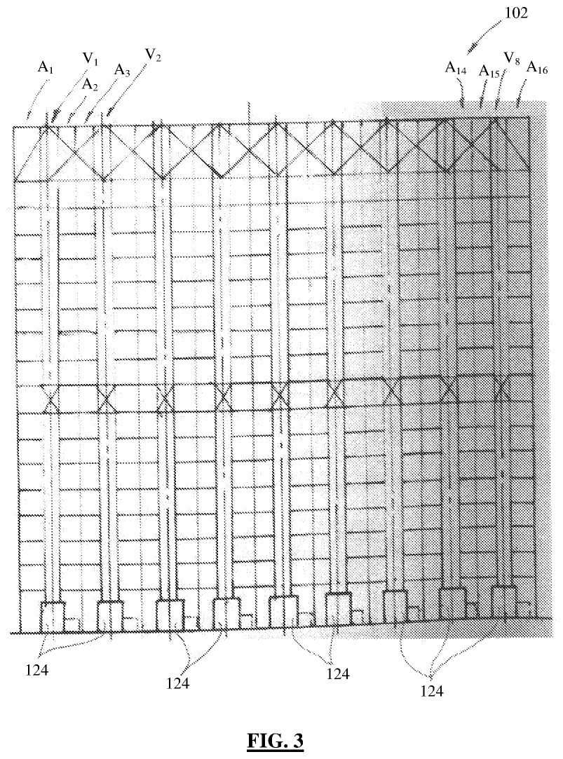

As best seen in FIG. 2, some of the columns of cells 104 are configured to receive longer containers 200 than others. Some of cells 104 are configured to receive 40 foot long containers 200, others to receive 30 foot long containers 200 and yet others to receive 40 foot long containers.

The hoist assemblies 108b are moveable horizontally with respect to the structure 102. In the illustrated embodiment, each hoist assembly 108b is self-propelled and mounted on rails 122 at the top of the structure 102, the rails extending horizontally between opposite ends of the structure, parallel to axis A, along either side of the associated void area V₁, V₂ . . . V₈. The hoist assembly 108b comprises an electric motor for rotating rollers of the hoist assembly to propel the hoist assembly along the rails 122. The hoist assembly 108b comprises at least four hoist cables 108b₁, each connected to a respective anchor point 108a₂, in the form of a pulley wheel, on the carrier 108a. Each of the cables 108b₁ is independently adjustable to facilitate independent adjustment of the vertical position of the anchor points 108a₂.

The carrier 108a interlocks with the hoist assembly 108b upon elevation of the carrier to the upper end of the associated void area V₁, V₂ . . . V₈. The hoist assembly 108b is locked against movement relative to the structure, including against movement along rails 122, unless the carrier 108a is interlocked with the hoist assembly.

In the illustrated embodiment, the latching formations 108c₁ comprise twistlocks configured to engage top openings 202 in upper corner castings of a container 200. The latching formations 108c₁ comprise a cam mechanism for extending and retracting the twistlocks in a vertical direction between an extended configuration and a retracted configuration. The latching formations 108c₁ are engageable with the openings 202, and interlocked with the container 200, in both the extended configuration and the retracted configuration, and when moving therebetween, such that the container 200 may be moved vertically by the extension or retraction of the latching formations. The container engagement assemblies 108c may be prevented from traversing rails 102c or 108a₁, for example by locking rollers 108c₃ and/or deactivating the motor of the container engagement assemblies 108c, unless the latching formations 108c₁ are in the retracted configuration. The latching formations 108c₁ are displaced vertically by less than a predetermined displacement when moving between the extended configuration and the retracted configuration. In the illustrated embodiment, the predetermined displacement is less than around 4 inches (approximately 100 mm). In other embodiments, the predetermined displacement may be greater than around 4 inches but: less than around 12 inches (approximately 300 mm), or less than around 8 inches (approximately 200 mm) or less than around 6 inches (approximately 150 mm). The height adjustable bearing modules 118 facilitate the latching formations 108c₁ only needing to be displaced vertically by a relatively small amount when a container 200 is inserted in or removed from a cell 104.

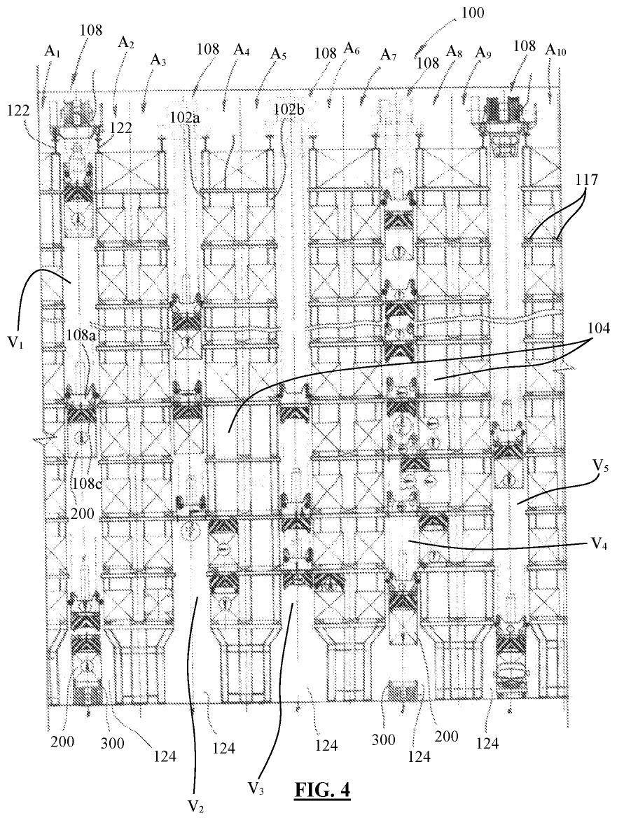

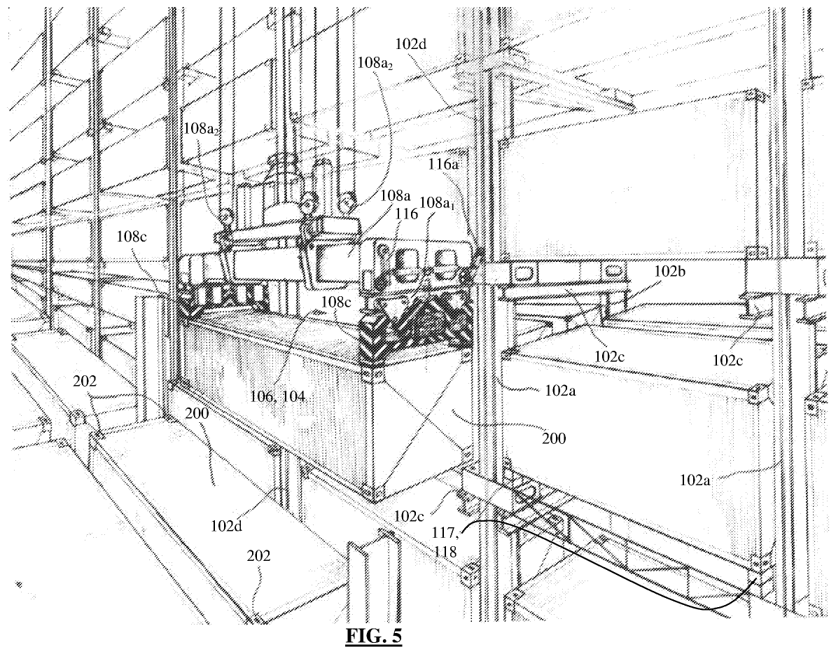

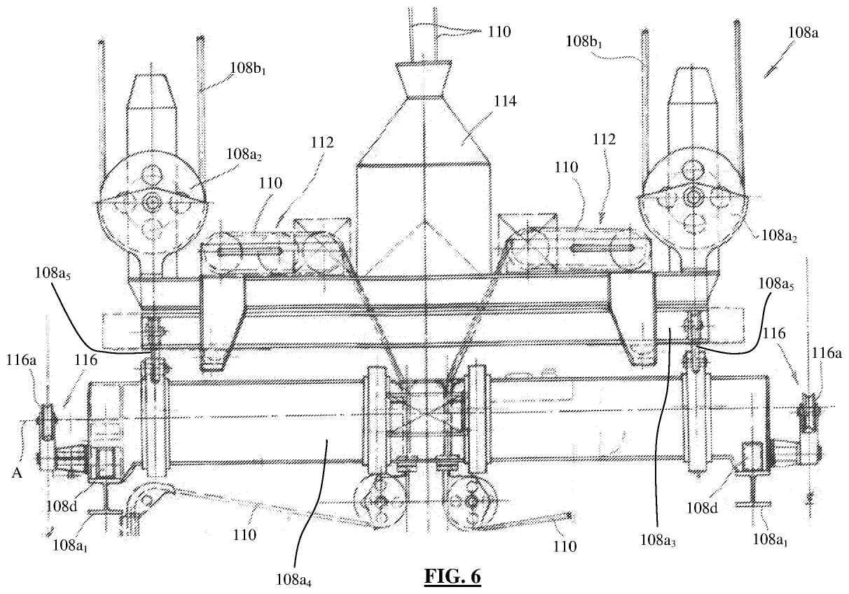

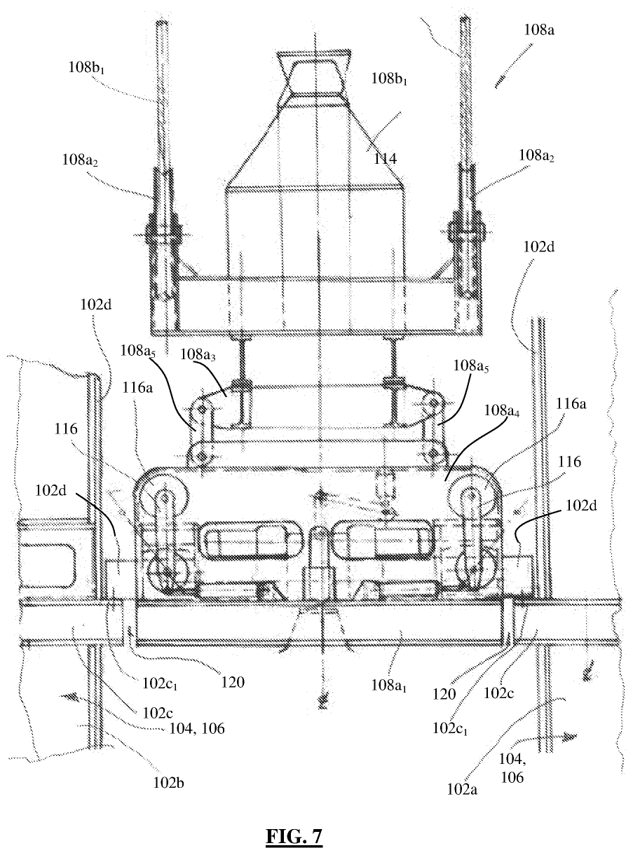

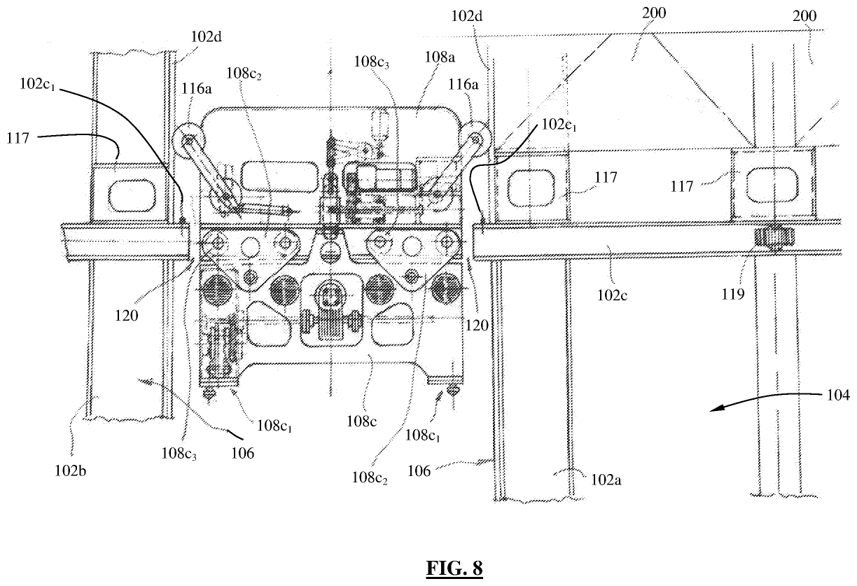

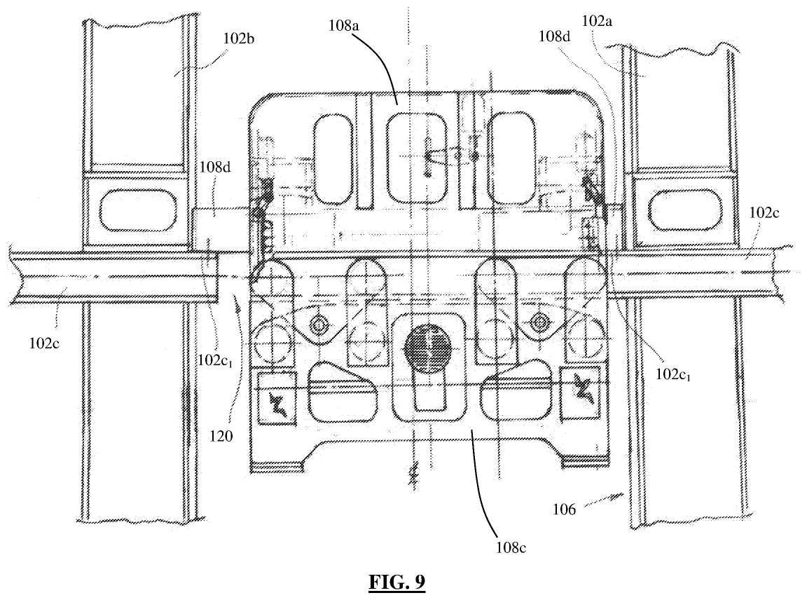

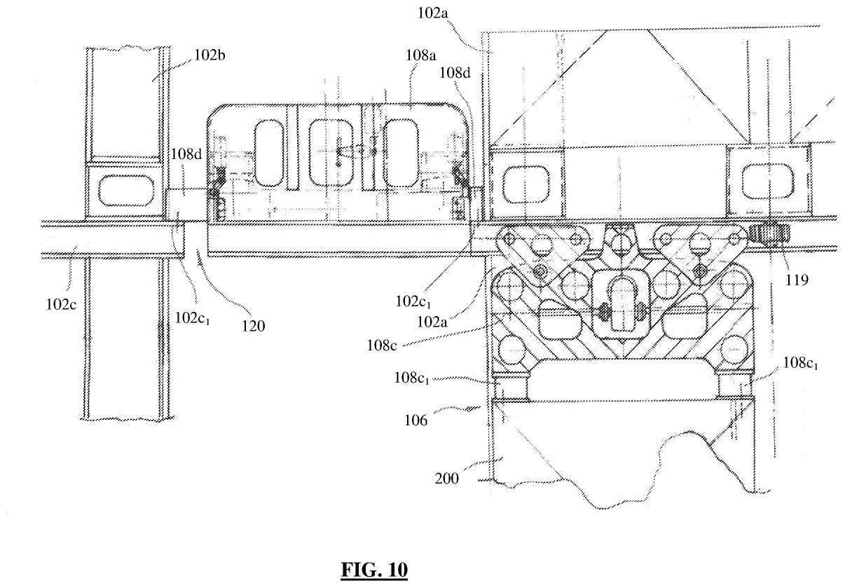

A container carrier bay 124 is provided at a lower end of each void area V₁, V₂ . . . V₈. In the illustrated embodiment, the bays 124 extend completely through the structure 102 between its opposite ends. The bays 124 are oriented parallel to the first axis A. Accordingly, a longitudinal axis of a container 200 carried on a container carrier 300, such as a truck trailer or train wagon, in the bay 124 is parallel to the first axis A. As shown in FIG. 4, the carrier 108a of container crane 108 is lowered to a container carrier 300 in bay 124 to: unload a container 200 from the container carrier and move the container into one of the cells 104; or deliver a container 200 from one of the cells 104 to the container carrier 300. As the carrier 108a enters the top of the bay 124, its position and orientation over the container carrier 300 can be adjusted by actuating linkages 108a₅ and/or by independent adjustment of hoist cables 108b₁.

Crane 108 comprises a weighing scale for determining the weight carried by the hoist mechanism 108b. An electronic crane controller adjusts operation of the crane 108, such as the speed at which the hoist mechanism 108b is operated, based on the weight determined by the weighing scale. For example, the controller may cause the crane 108 to raise, lower or traverse more slowly if the weight is higher, such as when the crane is carrying a full container 200, and may cause the crane to raise, lower or traverse more quickly if the weight is lower, such as when the crane is carrying an empty container or not carrying a container. When the crane 108 is moved between columns C₁, C₂ . . . C₁₅ of different lengths, parallel to axis A, the electronic crane controller also adjusts the length of the carrier 108a to match that of the column in which the crane 108 is to be operated.

System 100 comprises a container allocation system 130 for determining a preferred cell 104 in which to store an incoming container 200. Container allocation system 130 may allocate an incoming container 200 to a cell 104 based on a number of parameters, such as the dimensions and/or weight of the incoming container 200 and/or the weight distribution of containers 200 already stored in the structure 102. For incoming containers 200, container allocation system 130 may send a signal to an operator of an incoming container carrier 300, the signal directing the operator to:

move the container carrier 300 into the bay 124 associated with the preferred cell 104; and

stop the container carrier 300 in the bay 124 at a position in which the container carrier is aligned with the column C₁, C₂ . . . C₁₅ containing the preferred cell 104.

Similarly, for outgoing containers 200, the container allocation system 130 may send a signal to an operator of an outgoing container carrier 300, the signal directing the operator to:

move the container carrier 300 into the bay 124 associated with the cell 104 in which the outgoing container 200 is stored; and

stop the container carrier 300 in the bay 124 at a position in which the container carrier is aligned with the column C₁, C₂ . . . C₁₅ containing the outgoing container 200.

System 130 may also communicate with the electronic crane controller to cause the electronic crane controller to traverse the crane 108 of the relevant bay 124 to: in the case of an incoming container 200, the column C₁, C₂ . . . C₁₅ containing the preferred cell 104; or, in the case of an outgoing container 200, the column C₁, C₂ . . . C₁₅ containing the outgoing container 200. System 130 may also communicate with the electronic crane controller to cause the electronic crane controller to direct a crane 108 to move a container 200 between from one cell 104 to another, for example to improve the weight distribution of containers 200 stored in the structure 102 or to position certain containers 200 bound for the same onward destination closer together within the structure.

It will be appreciated that system 100 provides numerous advantages over prior art systems for handling and storage of ISO or intermodal containers, some of which are apparent from the description provided above. Examples of advantages of system 100 include structure 102 of system 100 facilitating stable storage of containers 200 irrespective of the number of cells 104 in each column C₁, C₂ . . . C₁₅. In other words, structure 102 facilitates stable storage of containers 200 in tall columns/stacks. Moreover, system 100 allows any container 200 stored in a cell 104 of structure 102 to be removed from the cell without shuffling, even if there are containers 200 present in the cells above and below. Similarly, system 100 allows a container 200 to be installed in any empty cell 104 of structure 102. In contrast, in prior art systems, a container can only be installed on the top of an existing container stack or on the ground. Accordingly, system 100 facilitates efficient storage and retrieval of containers 200 and also facilitates large numbers of containers 200 being stored on a smaller footprint than is possible with prior art systems in which containers are stacked directly one on top of another. Another advantage of system 100 is that it facilitates stability of container stacks, even in environments with high winds.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive. Examples of possible variations/modifications, include, but are not limited to:
some or all of the cells 104 being configured to store two or more containers 200 therein, such as two or more containers stacked on top of one another;
the void area may be alongside one group of cells 104, rather than being between two groups of cells 104;
carrier 108a may have a fixed length, and cranes 108 with carriers 108a of various fixed lengths may be provided to handle containers 200 of different lengths; and/or
there may be three hoist cables 108b₁ and three associated anchor points 108a₂ or there may be more than four hoist cables 108b₁ and a corresponding number of associated anchor points 108a₂.

1. A system for handling and storage of ISO or intermodal containers, the system comprising:
a structure having a plurality of storage cells therein, each of the storage cells being configured to store at least one ISO or intermodal container therein, a first number of the plurality of storage cells being located at a different vertical position within the structure to a second number of the plurality of storage cells,
a void area extending vertically through or alongside the structure,
a third number of the plurality of storage cells, the third number of the plurality of storage cells comprising at least some of the first number of the plurality of storage cells and at least some of the second number of the plurality of storage cells, and each of the cells of the third number of the plurality of storage cells:
being adjacent the void area, and
having a container access opening communicating with the void area; and
a container crane mounted relative to the structure and comprising:
an elongate carrier located in the void area, a longitudinal dimension of the carrier defining a first axis,
a hoist assembly mounted to the structure at an upper end of the void area, the hoist assembly connected to the carrier for adjusting a vertical position of the carrier relative to the structure,
first and second container engagement assemblies releasably engaged with respective opposite longitudinal ends of the carrier, each of the container engagement assemblies comprising latching formations for engagement with openings in corner castings of an ISO or intermodal container, the container engagement assemblies being disengageable from the carrier for lateral movement away from the carrier, out of the void area, and into a target cell of the third number of the plurality of storage cells via the respective access opening,
wherein, upon movement of the container engagement assemblies into the target cell, the container engagement assemblies engage and are vertically supported by a portion of the structure associated with the target cell,
wherein the structure comprises a plurality of horizontally spaced apart vertical members and a plurality of lateral members interconnecting the vertical members, each of the cells comprising a pair of parallel, spaced apart horizontal members at its upper end,
wherein said portion of the structure associated with the target cell comprises the pair of horizontal members of the target cell,
wherein the carrier comprises a pair of horizontal members having a cross sectional shape complementary to that of the horizontal members of the cells, and wherein, when engaged with the carrier, the container engagement assemblies engage and are vertically supported by the pair of horizontal members of the carrier.

2. The system of claim 1, wherein the container engagement assemblies are self-propelled.

3. The system of claim 2, wherein power supply cables for powering the container engagement assemblies extend from the carrier, wherein the power supply cables extend from an upper region of the structure, through the void area to a central region of the carrier, and outwardly from the central region of the carrier to the container engagement assemblies.

4-5. (canceled)

6. The system of claim 3, comprising a cable extension and retraction assembly for feeding the power supply cables to and retracting the power supply cables from the container engagement assemblies as the container engagement assemblies move relative to the carrier.

7-9. (canceled)

10. The system of claim 1, wherein the horizontal members of the carrier are perpendicular to said first axis.

11. The system of claim 9, wherein each of the container engagement assemblies comprises a roller assembly, comprising one or more roller(s), the horizontal members of the carrier defining a first track engageable by the one or more roller(s) of the roller assembly and the horizontal members of the cells defining a second track engageable by the one or more roller(s) of the roller assembly, wherein, when the container engagement assemblies transition between the carrier and the target cell, the roller assemblies transition between engagement with the first track and engagement with the second track.

12. The system of claim 1, comprising at least one bearing member extending from the target cell, outwardly into the associated void area, the carrier comprising a selectively extendable and retractable bearing element, the bearing element, when in an extended configuration, being engageable with the bearing member to support the carrier at a vertical position in which the container engagement assemblies are aligned with the portion of the structure associated with the target cell.

13. The system of claim 1, wherein the structure comprises a vertical third track engageable by the carrier, engagement between the carrier and the third track guiding the carrier, and thereby the first and second container engagement assemblies, during adjustment of the vertical position of the carrier relative to the structure.

14. The system of claim 13, wherein the carrier comprises selectively extendable and retractable guide members, the guide members, when in an extended configuration, engaging the third track.

15. The system of claim 1, wherein each of the cells, at its lower end, comprises at least four container bearing zones on which a container is placed for storage in the target cell, and wherein a vertical distance between each of the bearing zones and the portion of the structure associated with the target cell is adjustable to facilitate maintaining a constant distance between a top of a container stored in the target cell and the portion of the structure associated with the cell regardless of the height dimension of the container.

16-17. (canceled)

18. The system of claim 15, wherein a bearing module of adjustable height is associated with each of the bearing zones.

19-24. (canceled)

25. The system of claim 1, wherein said openings in corner castings of a container are top openings in upper corner castings of the container and the latching formations comprise twistlocks.

26. (canceled)

27. The system of claim 1, wherein the latching formations are extendable and retractable in a vertical direction between an extended configuration and a retracted configuration, and wherein the latching formations are engageable with the openings in corner castings of a container when in the extended configuration, and when in the retracted configuration, and when moving therebetween, such that the container is moveable vertically by the extension or retraction of the latching formations.

28. (canceled)

29. The system of claim 27, wherein the latching formations are displaced vertically by less than a predetermined displacement when moving between the extended configuration and the retracted configuration, the predetermined displacement being less than around 8 inches.

30. The system of claim 27, wherein the container engagement assemblies comprise camming mechanisms for moving the latching formations between the extended and retracted configurations.

31. The system of claim 1, comprising a container carrier bay at a lower end of the or each said void area, wherein the container carrier bay is oriented parallel to the first axis such that a longitudinal axis of a container carried on a container carrier in the bay is parallel to the first axis, and wherein the crane is configured for lowering to the bay to: unload a container from said container carrier in the bay and move the container into one of the cells; or deliver a container from one of the cells to said container carrier in the bay.

32-34. (canceled)
